(19) United States
(12) Patent Application Publication
(10) Pub. No.: US 2002/0144263 A1
(43) Pub. Date: Oct. 3, 2002

(54) Grouping of advertisements on an advertising channel in a targeted advertisement system

(76) Inventors: Charles A. Eldering, Doylestown, PA (US); Gregory C. Flickinger, Furlong, PA (US); John A. Schlack, Southampton, PA (US)

Correspondence Address: EXPANSE NETWORKS, INC., 300 NORTH BROADSTREET, DOYLESTOWN, PA, 18901, US

(21) Appl. No.: 09/824,434

(22) Filed: Apr. 2, 2001

Related U.S. Application Data
(60) Provisional application No. 60/229,156, filed on Aug. 31, 2000.

(51) Int. Cl. H04N 7/025; H04N 7/10; G06F 3/00; H04N 5/445; G06F 13/00; H04N 7/18; H04N 7/173

(52) U.S. Cl. 725/34; 725/42; 725/46; 725/118; 725/119; 725/78

(57) ABSTRACT

A method and an apparatus for grouping targeted advertisements on an advertisement channel. The advertisements may be grouped at a head end, at a central location, and delivered as a time division or channel division multiplexed by the advertisement group to the one or more subscriber ends. In time-division multiplexing, the advertisements corresponding to the advertisement groups are temporarily grouped together when transmitted. In channel-division multiplexing, each advertising group is assigned to a different advertising channel and the STBs are instructed to download all the advertisements on the particular advertisement channel to which it corresponds. In particular, for ATM transport, encoded video streams may be sent on one or more channels such as Virtual Path Identifier/Virtual Channel Identifiers (VPI/VCIs). To achieve ad grouping, one or more dedicated channels (i.e., VPI/VCIs) may be created and assigned to carry only ads of a particular group.

This application claims priority under 35 U.S.C. §119 (e) for provisional application No. 60/229,156 filed on Aug. 31, 2000.

### FIELD OF THE INVENTION

The invention pertains to advertising. More particularly, the invention pertains to targeted advertising toward an individual subscriber, such as in television programming delivery systems utilizing set-top boxes, memory enabled set-top boxes, and/or personal video recorders.

### BACKGROUND OF THE INVENTION

The traditional paradigm for delivering advertisements (ads) in the stream of television programming is herein termed linked advertising. Whether the television programming service is being provided by antenna broadcast, analog cable, digital broadcast satellite (DBS), digital cable, switched digital video (SDV) or any other means, generally all viewers of a particular program will see the same ads in the same order at the same times. In essence, each advertisement is “linked” to a particular point within a particular program. If any particular viewer is not viewing the particular program at the particular time, he or she will not see the advertisement. That is, in linked advertising, the advertisements are simply part of the data stream from the head end, i.e., from the central office of the television service provider to all subscribers of that service.

However, with modern digital television service methods, including SDV systems (in which television service is received over the telephone lines) via very high speed digital subscriber line (VDSL) and digital cable, both of which utilize the concept of addressable set-top boxes (STBs), more personalized service is now available. For instance, in both types of systems, two-way communication between the subscriber's set-top box and the service provider via the network is possible. Further, the service provider can send different data to different subscribers. In telephone based systems such as SDV, the service provider can actually send different information to any individual subscriber.

In fact, in one embodiment, the VDSL television delivery standard essentially is an access network utilizing asynchronous transfer mode (ATM) protocol. In digital cable systems, different data can be sent to different groups of customers.

Accordingly, it is an object of the present invention to provide an improved method and apparatus for grouping a plurality of advertisements in one or more advertisement channels so that the advertisements may be delivered to one or more subscribers via a network, such as a television service network.

It is another object of the present invention to provide a method and apparatus by which targeted advertisements can be inserted into the television program stream in a targeted fashion either by individual subscriber or by groups of subscribers on a network.

It is a further object of the present invention to provide a method and apparatus for providing targeted advertisements to individual subscribers or groups of subscribers on a network.

### SUMMARY OF THE INVENTION

The present invention is directed at providing a method and an apparatus for grouping targeted advertisements on an advertisement channel. The advertisements may be grouped at a head end (or at a central location), and delivered as a time-division or a channel-division multiplexed channel.

In time-division multiplexing (TDM), the advertisements corresponding to a particular advertisement group are temporarily grouped together prior to transmission. Subsequently, one or more advertisement groups are transmitted in pre-defined time periods. On the subscriber end, one or more subscriber equipments, e.g., set-top boxes (STBs), are notified of the timing of the groups of advertisements within a group and are instructed to download the advertisements during particular time periods, the time periods corresponding to the advertising group or groups to which it belongs. Furthermore, a schedule of the TDM multiplex may also be created and transmitted to the STBs wherein the schedule represents the scheduling of the TDM on the TDM channel (i.e., which groups of ads are transmitted at which times).

In channel-division multiplexing, a plurality of advertisements are grouped into one or more groups and each advertising group is assigned to a different advertising channel. The STBs are instructed to download all the advertisement on a particular advertisement channel to which they correspond. In particular, for ATM transport, encoded video streams are transmitted on one or more channels, such as Virtual Path Identifier/Virtual Channel Identifiers (VPI/VCIs). To achieve ad grouping, one or more dedicated channels (i.e., VPI/VCIs) may be created and assigned to carry only ads of a particular group. More specifically, in an SDV system, different ad channels (corresponding to different ad channels) may be created and transported on different VPI/VCIs.

While the invention is particularly suitable for providing targeted advertisements into television programming, the invention is readily adaptable to providing any particular data into any particular stream of other data transmitted via a communications system. Such systems can include targeted advertising in Electronic Program Guides (EPGs) or digital overlay/insertion systems.

These and other features and objects of the invention will be more fully understood from the following detailed description of the preferred embodiments which should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 is a block diagram of an exemplary television service communication network;

FIG. 2 is a block diagram of an exemplary set-top box of FIG. 1;

FIG. 3 illustrates the grouping of ads based on time-division multiplexing (TDM) techniques;

FIG. 4 illustrates an exemplary time-division multiplexing channel of advertisement groups;

FIGS. 5 and 6 illustrate ad groups delivered on separate ad channels (VPI/VCIs);

FIG. 7 illustrates an exemplary distinct group ad channel delivered via a distinct fiber node in a Hybrid Fiber Coaxial (HFC) based system;

FIG. 8 illustrates an exemplary Local Multipoint Distribution System/Multichannel Multipoint Distribution System (LMDS/MMDS) ad channel architecture; and

FIG. 9 is a functional block diagram illustrating advertisement scheduling and advertisement insertion according to one embodiment of the present invention.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

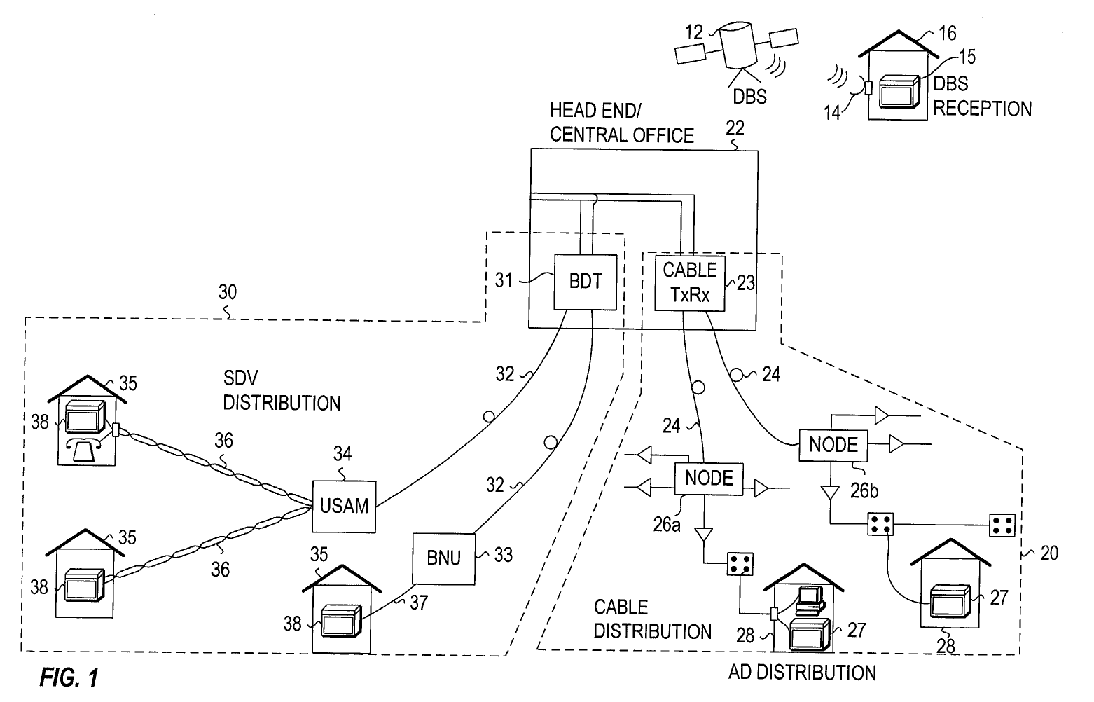

With reference to the drawings, in general, and FIGS. 1 through 9 in particular, the apparatus of the present invention is disclosed.

FIG. 1 generally illustrates three of the most common types of digital television service delivery networks with which the present invention can be suitably used. These include (1) VDSL, (2) digital cable and (3) digital broadcast satellite (DBS). In a digital broadcast satellite system, a programming stream comprising upwards of a hundred channels of television programming is delivered directly from a geo-stationary satellite transmitter 12 orbiting the earth to a receiving antenna 14 mounted on or near each subscriber's house and from the antenna via a cable to a satellite receiving station 15 in the subscriber's house 16. The satellite receiving station 15 (which is a form of set-top box) selects a channel and demodulates the signal for delivery to a monitor (e.g., a television, not shown). Most DBS systems are arranged such that data also can be sent in the upstream direction, that is, from the set-top box 15 to the DBS provider. In most DBS systems, the set-top box also is coupled to the telephone line and is designed and programmed to place telephone calls to the DBS service provider to periodically send information in the upstream direction. Such information commonly may comprise requests for Pay-Per-View programs or requests for changes in the subscription (a request that one or more premium channels be added to the service, etc.).

In a typical digital cable network 20, multiple channels of television information are transmitted from a head end or central office 22 via a cable network. Particularly, the channels are transmitted via cables 24 to nodes 26. The nodes are essentially switching/routing stations which service multiple homes (usually a few hundred). The nodes 26 route the signals to individual subscribers 28. The individual subscriber will have set-top boxes 27 that select a particular channel from the transmit stream, demodulate it and forward it for display on one or more monitors or televisions (not shown). Different data streams can be sent to the different nodles 26 of the network such that households coupled to node 26a can receive different programming than households coupled to node 26b. Thus, such systems are “addressable” by node, but not by individual subscriber. Upstream information may be sent from the set-top box to the central office via a dedicated upstream channel over the cable. In cable systems that do not support two-way communication, the upstream “channel” can be through the telephone as described above in connection with DBS systems.

In accordance with a third common type of system, namely, Switched Digital Video (SDV) 30, television programming is transmitted over the regular telephone network. Particularly, television signals are transmitted from a broadband digital terminal (BDT) 31 (located a central office 22) via wire, typically fiber optic cable 32, to a universal service access multiplexer (USAM) 34 which then delivers the data to multiple individual subscriber households 35 via regular telephone twisted wire pair 36 using VDSL modems and protocols. The USAM 34 receives a wide bandwidth signal comprising some or all of the television channels. However, because of the bandwidth limitations of twisted wire pair, typically only about one channel of television programming at a time can be delivered from the USAM to the household. Accordingly, the subscriber has a set-top box 38 that is similar in functionality to the set-top box of a digital cable system or DBS system, except that when the user changes channels such as by operating a remote control, the remote channel change signal is received by the STB and transmitted to the USAM 34 which switches the channel for the user and begins sending the newly selected channel to the household. SDV systems are essentially fully modern asynchronous two-way communication networks. Accordingly, the set-top box can transmit information upstream via the same VDSL modem that receives the downstream signals. SDV systems typically operate using an asynchronous transfer mode (ATM) protocol which is well-known in the networking arts. In an alternative embodiment, the signals are transmitted from the central office 22 to a broadband network unit (BNU) 33. The BNU 33 delivers the data to individual households 35 using coaxial cable 37.

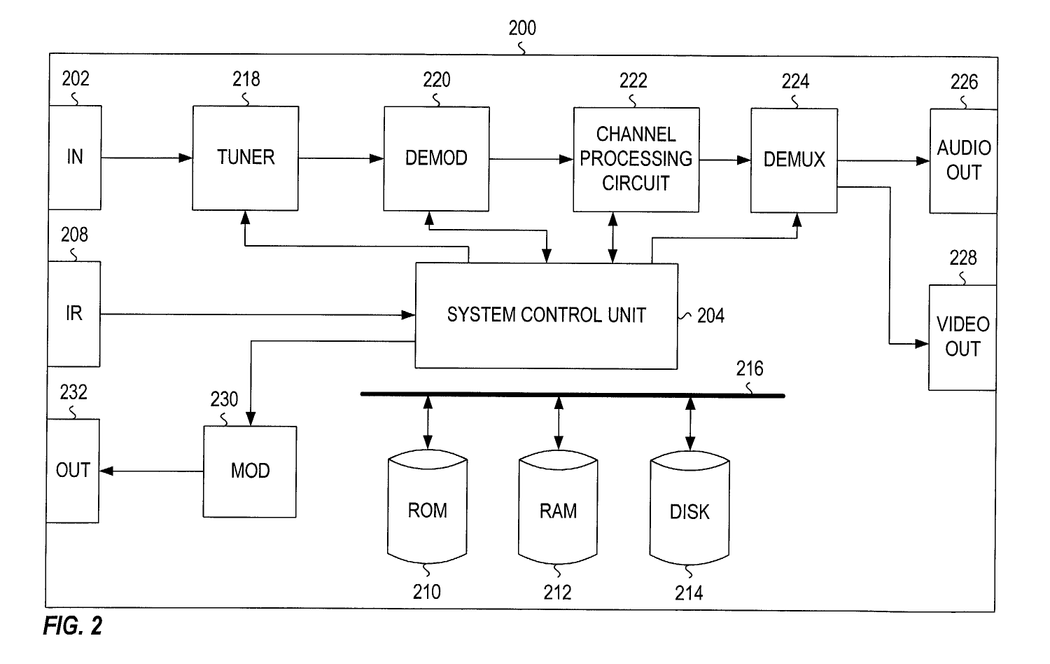

FIG. 2 is a block diagram showing the basic components of a set-top box 200 within which the present invention may be incorporated, whether it be for DBS, SDV, digital cable or any other system. The set-top box 200 includes an input port 202 for coupling to the input signal, e.g., a coaxial cable in the case of analog or digital cable TV, the telephone line in the case of SDV or an input cable from an antenna in the case of DBS. The television input signal may be analog or digital. Alternatively, the signal may be a video stream or multimedia stream such as a motion picture expert group (MPEG) signal from any communications network, such as the Internet. The set-top box includes a system control unit 204 which controls operation of the components of the STB. The system control unit essentially is a central processing unit (CPU) and may be any digital processing device, such as a microprocessor, finite state machine (FSM), digital signal processor (DSP), application specific integrated circuit (ASIC), general purpose computer, etc. The system control unit 204 receives commands from the subscriber, such as through infrared (IR) reception of commands from a handheld remote control unit (not shown) through an IR receiving circuit 208, decodes the commands and forwards control signals to other circuits in the set-top box 200 in order to carry out the subscriber's commands, such as changing the channel. The STB further includes a read only memory (ROM) 210 containing software and fixed data used for operating the STB, and a random access memory (RAM) 212 for storing changeable data, such as the queues and advertisements in accordance with the present invention. Preferably, the STB also includes a separate internal or external large memory device, such as a hard disk drive 214 or optical disk drive for storing the very large amounts of data that comprise digital multimedia data, e.g., television programs and advertisements. The SCU 204, RAM 212, ROM 210 and hard disk 214 are coupled to a master bus 216 over which the units can communicate with each other.

The input signal from input port 202 is passed through a tuning circuit 218. Under control of the system control unit 204, the tuning circuit selectively parses out the data corresponding to the particular channel selected by the viewer. That data is passed to a demodulator 220 that demodulates the data. A channel processing circuit 222 takes the demodulated channel data and processes it as needed. The necessary channel processing may comprise almost nothing to significant processing of the data depending on the particular form of the input data and the features of the STB which would be familiar to persons of skill in the related arts. Exemplary functions that might be performed in the channel processing circuitry include decoding an encoded data stream (e.g., MPEG, Dolby SurroundSound?) or inserting advertisements into the data stream in accordance with the present invention.

If received data is to be stored locally at the STB, the channel processing circuit can pass the data to one of the memory devices 212 or 214 through the system control unit 204.

The output of the channel processing circuit typically is coupled to a demultiplexer 224 which separates the audio and video portions of the channel and forwards them to audio and video output ports 226 and 228, respectively.

Tuner 218 and channel processing circuit 222 are controlled by the system control unit 204. However, the demodulator and demultiplexer may also need control.

Many STBs also can transmit data upstream to the head end. Such STBs would include a modulator 230 coupled to the system control unit for modulating data generated in the system control unit for transmission to the head end as well as an output port 232 for coupling a cable or other link to the head end. It is to be noted that the input port 202 and output port 232 might comprise the same physical port.

A set-top box for an SDV network typically would not include the tuner 218 since, as indicated above, channel selection is not processed in the set-top box but is merely transmitted to the USAM for processing.

It will be apparent to those of skill in the related arts that FIG. 2 is a very high level depiction of the most basic components of an STB and that other forms are possible.

The invention will now be described in connection with the particular embodiment in which groups of advertisements are created for the purpose of inserting targeted advertisements into television programming. However, it should be noted that the invention may be used to insert any data into any other data stream. For instance, the invention can be applied to the Internet, streaming audio data, etc. It also may be applied to insert advertisements in the electronic program guides that are frequently provided in one channel of television programming and which commonly include advertisements in a portion of the display. The system can also be utilized for the management of advertisements which are provided directly into a portion of the screen during the actual programming, such as those advertisements which are electronically placed on the billboards in sports arenas or on the field. Such advertisement placement (insertion) technology is commercially available from companies such as Princeton Video Image, Inc., of Lawrenceville, N.J. Preferably, the information stream includes particular time intervals which are dedicated for insertion of such external data. However, the invention can be utilized to replace existing data in the data stream, if desired. In the nomenclature of the specification, such designated intervals are termed avails.

In accordance with a preferred embodiment of the invention, the various television programming channels include open commercial breaks designated specifically for the insertion of ads by the television service provider. That is, the normal stream of information in the channel includes blank intervals so that an advertisement from a source external to the channel data itself can be inserted into that interval. The avails may also be created when a program is recorded on a set-top box with memory or a personal video recorder. In such instances, the consumer may agree to watch advertising prior to, during, or even after a recorded program is played back. The present invention can thus be used to manage advertisements in recorded video streams. The advertisement insertion can be performed as the programming is being recorded, as it is played back to the monitor, or even between recording and playback by rearranging the content in memory to add the advertisements.

Also, in accordance with the invention, there should be some means by which the set-top box can determine the location and preferably the duration of avails. Several different means for performing this function are possible. For instance, PCT Patent Publication No. WO 99/66719, the disclosure of which is incorporated hereby by reference, discloses several means, such as detecting the black frames which television programmers typically provide in the video stream at the beginning of a television commercial avail. Alternatively, DVS-253, a digital video standard for television promulgated by the Society of Cable and Television Engineers (SCTE), provides for digital cue tones within the data stream indicating the start of commercial avails. In an analog television data stream, an avail indicator can be embedded within the vertical blanking interval which can be detected by the set-top box. The indicator can include information indicating the duration of the avail.

In accordance with the invention, the set-top box (1) determines whether the box is turned on and, if so, to what particular channel it is tuned, (2) detects avails in that channel, and (3) inserts the identified advertisements in the order indicated into the avails as they arrive.

Thus, in accordance with the invention, the advertisements are no longer linked to any particular advertisement spot in any particular program. In accordance with the invention, a virtual map may be created whereby the subscriber will receive the designated ads in the designated order as avails occur in whatever programming he or she is viewing, regardless of the channel, program or time of day. In this manner, the advertisers can more specifically reach their target audience while also being given a much higher level of confidence that their ads have actually been viewed by the target audience.

With traditional linked advertising, the advertiser pays to have an advertisement displayed in a designated time slot in a designated channel regardless of who or how many viewers are tuned to the channel at that time. In accordance with the present invention, the advertisement is not played to any subscriber unless that subscriber's set-top box is turned on. Further, the advertisement is played in the channel to which the set-top box is tuned, thus virtually guaranteeing that the subscriber actually sees the advertisement that the advertiser has paid to have displayed.

Even further, the television service provider can address individual STBs or at least groups of STBs depending on the particular network and instruct them to insert particular advertisements. Accordingly, the television service provider can sell advertising space to advertisers in a much more targeted fashion than in the prior art.

The advertisement identifiers are transmitted to the individual set-top boxes for storage from the central office of the television service provider in any reasonable manner. Preferably, the advertisements themselves are also transmitted to the STBs for storage until they are “played”. Several manners are well known in connection with existing digital cable and VDSL systems for transmitting data to individual receiving nodes coupled to the network. For instance, VDSL systems essentially operate on an asynchronous transfer mode (ATM) protocol with video typically being carried as MPEG data. In digital cable and DBS systems, the advertisements can be delivered in MPEG transport streams.

Numerous means are available for delivering advertisements to the set-top boxes for storage in the set-top boxes. Common to all of these architectures are multiple forward channels (head end transmitting to STBs) and one return channel (STB transmitting to the head end). One of the forward channels (hereinafter the advertisement channel) may be dedicated to delivering the advertisements, metadata about the advertisements, ARLs, and instructions for the STBs regarding how the advertisements are to be organized. The return path/channel is used for, among other things, communicating to the service provider what ads are stored at the STB, what ads have been played and when, what ads are scheduled for play, etc. Such information is critical for selling and charging the advertisers for playing the ads. The return path typically would be a low bandwidth channel since the amount of data transmitted upstream is very limited relative to the video and audio data which is transmitted in the downstream channels. Also, as previously noted, the return path need not be through the same network as the downstream path. For instance, as discussed above in connection with SDV or DBS, the return path can be through a modem via POTS (Plain Old Telephone Service).

In one exemplary embodiment, a service provider (DBS, cable, SDV, local multipoint distribution system) allocates and dedicates one or more channels of the system to be used for delivering nothing but advertisements and advertisement metadata. This channel could be a high bandwidth (e.g., 6 MHZ) channel. The channel would be encoded and transported in the same manner as any other programming content channel on the system and would include all advertisements that are intended for display to any subscriber on the network.

The STBs could be pre-programmed with advertisement maps which indicate which types of advertisements they are to download from the advertisement channel and which they can ignore.

In one embodiment, each advertisement can have a tag associated with it (e.g., embedded within it or linked to it). This tag could be a simple identifier or a complete advertisement vector describing many characteristics of the advertisement. Such metadata could be transported with the advertisement or in advance of the ad.

Each STB contains in memory a map which tells the STB the particular advertising group or groups to which it belongs, the group or groups depending on the demographic, psychographic or other information available to the cable service provider about the owner of the STB.

This tag or vector can be detected by the STB to determine whether or not to store the advertisement and when and how to display the advertisement. Such determination can be accomplished in a number of ways depending on the application. If the tag is a simple identifier (of the advertisement or the advertisement group to which it belongs) and is sent with the ad, the STB could examine the tag on the fly as the advertisement is received and either save it or ignore it based upon the instructions/rules preprogrammed into the STBs advertisement map.

The tags would indicate for which one (or more) of a plurality of advertising groups the advertisement is intended. The STBs pick out and store those ads that have a matching advertising group in the tag to the advertising group or groups in the STBs advertising group map.

The advertisement maps can be preprogrammed into the STB before it is delivered to the subscriber. However, more preferably, the maps are sent to the STBs via the network on a periodic basis, such as is done via a carousel mechanism. In one embodiment, each advertisement is assigned a unique identifier. Each advertisement also is assigned to one or more target groups (i.e., subscribers) for which it may be appropriate. The television service provider constructs a map which indicates, for each unique advertisement identifier, the target groups for which that advertisement is intended. The entire map can be sent to each STB so that each STB can utilize the map to identify and pick out the appropriate ads. Alternately, individual tables for each individual advertising group can be generated at the central office and sent to the appropriate STBs. In either case, the STB processor having the table examines each advertisement identifier and compares it to its table. If the advertisement identifier matches one contained in its table, the STB would pick out that advertisement and save it. Otherwise, it would ignore the ad.

In another embodiment, the ads may be grouped at a central location, e.g., a head-end delivered on the advertisement channel(s) could be time-division or channel-division multiplexed by advertising group. In time-division multiplexing, the advertisements corresponding to advertising groups are temporally grouped together prior to transmission. The STBs could be instructed to download all advertisements sent on the advertisement channel during particular time periods, those time periods corresponding to the advertising group or groups to which it belongs. In channel-division multiplexing, each advertising group is assigned to a different advertising channel. The STBs are instructed to download all advertisements sent on the particular advertisement channel(s) to which it corresponds.

In a system such as SDV which operates on an ATM protocol, because the ATM switching occurs at the central office, the central office is able to direct different advertisement channels to one or more of its subscribers'STBs on different VPI/VCIs. In this type of embodiment, one or more advertisement channels corresponding to one or more specific subscribers could be created and sent to the appropriate subscriber(s). Each STB would be instructed to tune to a particular advertisement channel, e.g., (VPI/VCI), in order to receive and store all the ads on that particular channel. This type of embodiment is advantageous in that the STBs would not need to filter the ads since each advertisement received on the channel would be appropriate for that STB. In such a system, the central office would typically have its own advertisement server for generating the advertisement channel.

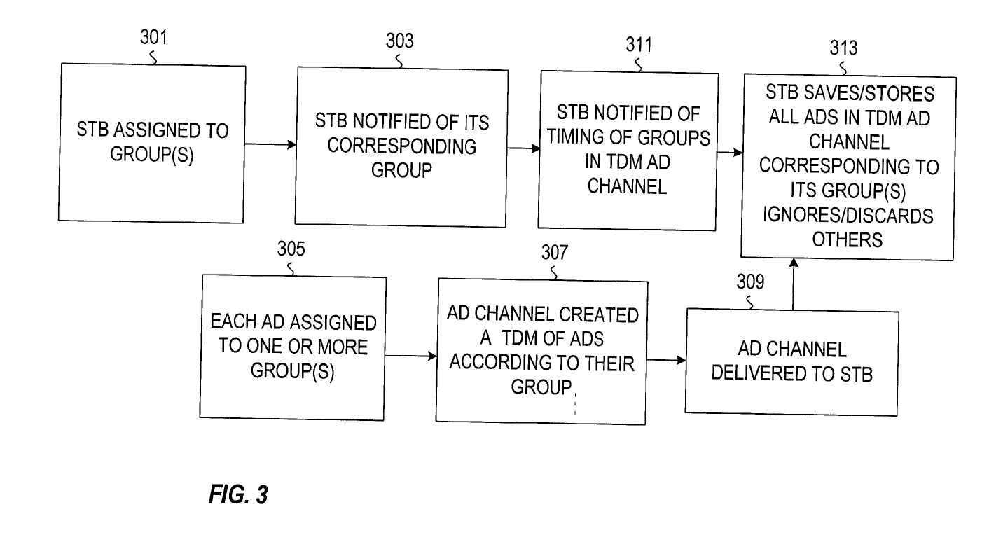

FIG. 3 illustrates an exemplary TDM process in accordance with one embodiment of the present invention. In this embodiment at step 301, the STB is assigned to one or more groups based on pre-defined parameters. At step 303, each STB is notified of its corresponding group. At step 305, each ad is assigned to one or more groups. Subsequently, in step 307, an advertisement channel is created wherein the advertisement channel is a time-division multiplexing of a plurality of advertisement groups. In step 309, the ads are transmitted to the STB via an ad channel with groups of ads being transmitted together (i.e., a temporally contiguous sequence of ads belonging to the same group is sent). Thus, each group of ads is sent in the form of a TDM. A ‘schedule’ of the TDM multiplex (not shown) may also be created and transmitted, wherein the TDM multiplex represents the scheduling of the TDM on the ad channel (i.e., which groups of ads are transmitted at which times). In step 311, each STB is notified of the timing of groups in the transmitted TDM channel. In step 313, the STB, based on the received schedule (i.e., the timing of groups of ads in the multiplex), and depending on which group(s) it belongs, extracts and saves those groups of ads in the multiplex appropriate for the STB. The remaining ads (not belonging to the STB group) are ignored by the STB.

It is to be noted that the system clocks (not shown) both at the STB and the origination of the TDM multiplex may require synchronization. The schedule could indicate both the start and end times of the ad groups in the TDM, or alternatively, could indicate the start time only and a duration. The STB, knowing to which groups it belonged and knowing the schedule of the ad-groups in the multiplex, could selectively save those ads appropriate for it.

The TDM ad grouping mechanism can also be implemented utilizing the new “digital cue tone” standard (DVS-253). This standard specifies new data services for each elementary stream allowing for timing information to be sent along with the stream when a splice of that stream is appropriate (both splicing into and out of the program). Such splicing timing can be encoded in the ad channel program stream (i.e., the program of continuous ads), but instead of being used to indicate a splice event, the timing information would be used to determine when to start receiving (and storing) ads and when to stop. The new splice-timing service may be adapted to yield the timing of the beginning and end of an ad-group sequence in the TDM multiplex. A new data service may also be created for this purpose.

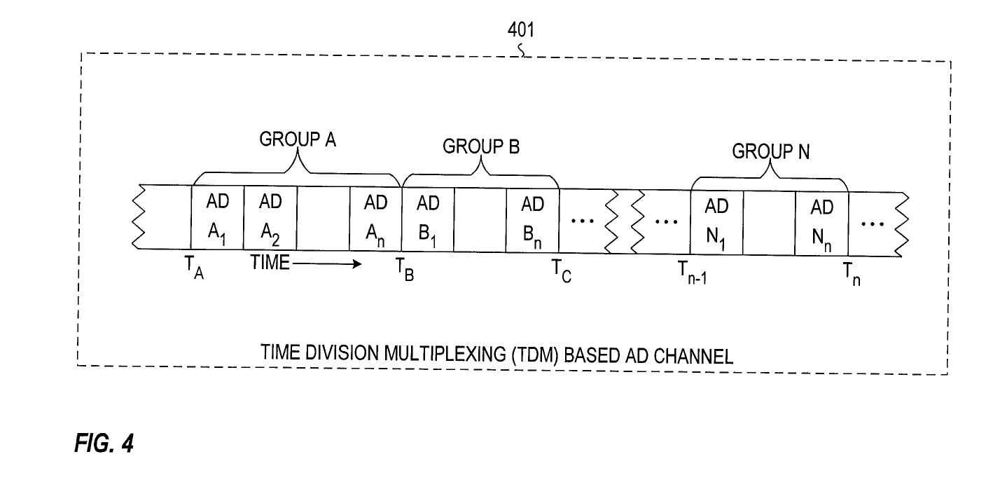

FIG. 4 illustrates an exemplary time-division multiplexing channel comprising a plurality of advertisement groups.

In FIG. 4, a time-division multiplexing (TDM) ad channel 401 is shown to have a plurality of time slots, each time slot based on a time multiplex. For exemplary purposes, in FIG. 4, a plurality of time slots, T_{A}, T_{B}, T_{c}, Tₙ₋₁−Tₙ are also shown, wherein T_{B}−T_{A} corresponds to a first time multiplex. Similarly, T_{C}−T_{B} corresponds to a second time multiplex, Tₙ₋Tₙ₋₁ to another time multiplex, etc. Furthermore, each time multiplex is shown to host a plurality of advertisements, e.g., time multiplex T_{B}−T_{A} hosts advertisements corresponding to group A (labeled as A₁, A₂ - - - Aₙ), T_{C}−T_{B} hosts advertisements corresponding to group B (labeled as B₁, B₂ - - - Bₙ) and Tₙ−Tₙ₋₁ hosts group N advertisements (N₁, N₂ - - - Nₙ), etc.

Another method for delivering “grouped” ads to the STB and storing only those ads appropriate for that STB can be accomplished by creating a separate ad “channel” for each ad group, and sending to each STB only that ad channel which corresponds to its groups (i.e., that channel which has ads appropriate for that STB). For ATM transport, encoded video streams may be sent on one or more individual channels, e.g., VPI/VCIs. For example, one or more dedicated channels (i.e., VPI/VCIs) may be created and assigned to carry only ads of a particular group. This would result, in one embodiment, in a VPI/VCI for each advertisement. It is to be noted that each VPI/VCI may be a high, moderate, or low bandwidth channel. More specifically, in an SDV system, different ad channels (corresponding to groups) may be created and transported on different VPI/VCIs. Each STB, being a member of one group would receive the ad channel corresponding to its group. It is also to be noted that the switching of the different ad channels (VPI/VCIs) may occur at a central location, e.g., at the broadband digital terminal (BDT), the appropriate ad channel being sent to each STB (and only that particular ad channel).

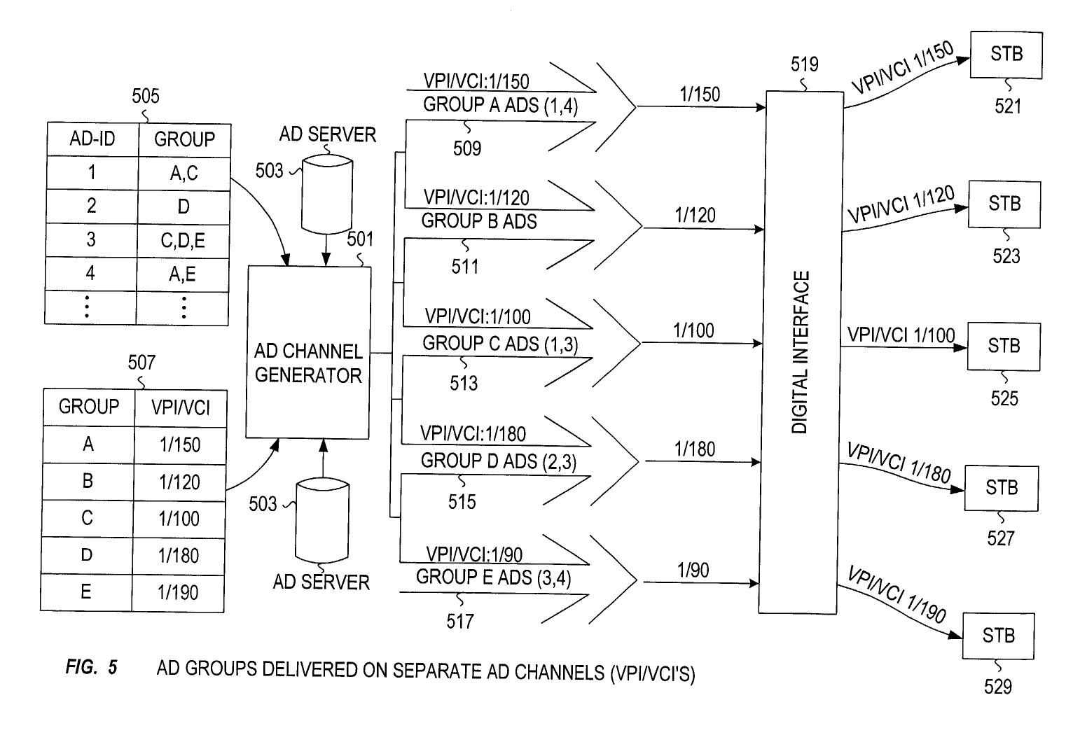

FIG. 5 shows one such exemplary implementation in accordance with another embodiment of the present invention. In this embodiment, each ad is assigned to one or more groups and a VPI/VCI is created for each advertisement group. An ad channel comprising only ads belonging to a particular group is transmitted on the VPI/VCI assigned for that group. The STB has a map table (GROUP-VPI/VCI) indicating which VPI/VCI(s) correspond to which group(s), thus allowing the STB to “tune” to the proper VPI/VCI (corresponding to the group of the STB) in order to receive ads appropriate for it. The tuning at the STB means that only that VPI/VCI (i.e., the appropriate ad channel) may be switched and transmitted to the STB.

As shown in FIG. 5, an ad channel generator 501 may receive one or more advertisements from one or more ad servers 503. The ad server 503 stores the actual contents of the advertisements. The ad channel generator 501 also receives information from an AD_ID-GROUP table 505, wherein the AD_ID-GROUP table refers to the assignment of each advertisement to a group. In one embodiment, each advertisement may be assigned an identification AD_ID, and via this AD_ID, each advertisement may be linked to a group, each group labeled as A, B, C, D, E, etc.

Similarly, the ad channel generator 501 also receives information from a GROUP-VPI/VCI table 507, wherein each GROUP-VPI/VCI table 507 refers to associating groups of advertisements to corresponding VPI/VCI. The GROUP-VPI/VCI table 507, for example, may indicate that GROUP A advertisements belong to VPI/VCI 1/150, and GROUP B advertisements belong to VPI/VCI 1/120, etc.

It is to be noted that the AD_ID-GROUP table information and the GROUP-VPI/VCI table information may be generated by a network operator or any other advertisement management system. It is also to be noted that even though FIG. 5 illustrates AD_ID group table generation and group VPI/VCI table generation processing located externally to the ad channel generator 501, in other embodiments such processing may be incorporated within the ad channel generator 501.

The ad channel generator 501 based on the information from the AD_ID-GROUP table 505, and from the GROUP-VPI/VCI table 507, creates one or more ad channels, wherein each ad channel comprises only one group of advertisements. Thereon, each group of advertisements is transmitted on a VPI/VCI assigned to that group. For exemplary purposes, the ad channel generator 501 generates five ad channels labeled as 509, 511, 513, 515, 517, wherein ad channel 509 comprises GROUP A ads, ad channel 511 comprises GROUP B ads, ad channel 513 comprises GROUP C ads, ad channel 515 comprises GROUP D ads, and ad channel 517 comprises GROUP E ads. Subsequently, GROUP A ads are transmitted at VPI/VCI:1/150, GROUP B ads are transmitted at VPI/VCI:1/120, and GROUP C ads are transmitted at VPI/VCI:1/100. Similarly, GROUP D ads are transmitted as VPI/VCI:1/180, and GROUP E ads are transmitted at VPI/VCI:1/190.

The VPI/VCI information and corresponding advertisements information may further be forwarded to a digital interface 519, e.g., a broadband digital terminal (BDT), wherein the VPI/VCI information may be correlated with the MAC_IDs of the set-top boxes (STBs) to determine which VPI/VCI should correspond to which STB terminal. The BDT may comprise a determination processing/circuitry (not shown) to correlate the VPI/VCI to the STBs. This correlation may be based on any number of parameters, e.g., subscriber demographics, subscriber likes and preferences, etc.

In FIG. 5, for exemplary purposes, VPI/VCI 1/150 is shown to be transmitting to a first STB, labeled 521, VPI/VCI 1/120 is shown to be transmitting to a second STB labeled 523, VPI/VCI 1/100 is shown to be transmitting to a third STB labeled 525, VPI/VCI 180 is shown to be transmitting to a fourth STB labeled 527, and VPI/VCI 1/190 is shown to be transmitting to a fifth STB labeled 529.

It is to be noted that the correlation of STBs to the VPI/VCI channels may be accomplished by creating a GROUP-VPI/VCI table, wherein the MAC_IDs of the STBs are correlated to the groups of advertisements they should be receiving, wherein the groups of advertisements are further correlated to the VPI/VCI information.

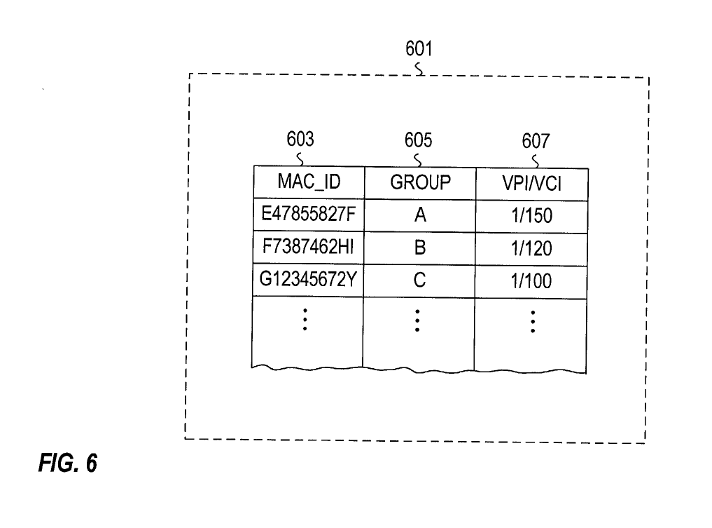

FIG. 6 illustrates an exemplary GROUP-VPI/VCI table 601. For exemplary purposes, the GROUP-VPI/VCI table 601 is shown to have a MAC_ID column 603, an advertisement group column 605, and a corresponding VPI/VCI column 607. Different columns of GROUP-VPI/VCI table 601 illustrate how different STBs (identified by MAC_IDs) may be assigned to different groups and corresponding VPI/VCIs.

It is to be noted that FIGS. 5 and 6 are particularly useful for SDV environments. A similar method may be employed in a cable system (e.g., a Hybrid Fiber Coaxial (HFC) based system. In cable-based systems, one or more separate ad channels may be created corresponding to one or more advertisement groups. Furthermore, each node within a cable system may be associated with an advertisement group and each node may receive only that ad channel corresponding to the node group. It implies that the ad channel switching/insertion occurs at the head end (HE). In one embodiment, a processor at the HFC system providing video services and a generic ad channel, may generate different ad channels (for different nodes/groups) and send only the one and appropriate ad channel to each node depending on the group membership of that node.

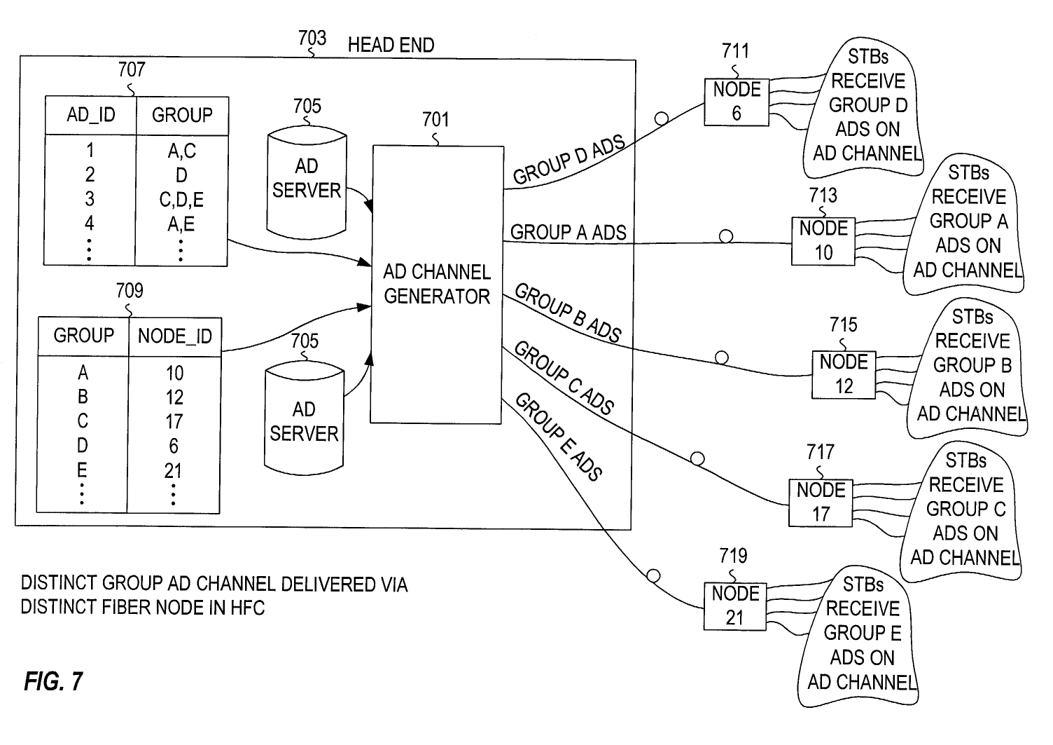

FIG. 7 illustrates an exemplary implementation in accordance with another embodiment of the present invention. In the exemplary implementation of FIG. 7, an ad channel generator 701 located at a head end 703 of the cable system may receive one or more advertisements from one or more ad servers 705. The ad channel generator 701 also receives information about the association of each advertisement to a group. This association may be represented by an AD_ID-GROUP table, labeled as 707, wherein, each advertisement is assigned an AD_ID and the AD_ID-GROUP table lists how each AD_ID corresponds to a group. The ad channel generator 701 also receives information about correlations between advertisement groups in different nodes.

In FIG. 7, ad channel generator 701 is shown to receive information about the correlation of advertisement groups to corresponding nodes. This correlation may be represented as a GROUP-NODE_ID table 709 wherein each cable node is identified by a NODE_ID and the GROUP-NODE_ID illustrates how each node corresponds to a group.

The ad channel generator 701, based on the AD_ID-GROUP table information and GROUP-NODE_ID table information transmits different advertisement groups to different cable nodes via a wire line or wireless link. For exemplary purposes, group D ads are shown to be transmitting to node 6 (711), group A ads are shown to be transmitting to node 10 &713), group B ads are shown to be transmitting to node 12 (715), group C ads are shown to be transmitting to node 17 (717), and group E ads are shown to be transmitting to node 21 (719).

In a cable-based network as shown in FIG. 7, the STBs corresponding to the serving node receives the same group of advertisements. For example, the STBs served out of node 6 receive group D ads. The STBs served out of node 10 receive group A ads, the STBs served out of node 12 receive group B ads, the STBs served out of node 17 receive group C ads, and the STBs served out of node 21 receive group E ads, etc. However, unlike prior art, the advertisements are targeted (selected) based on the node characteristics.

The information about node characteristics may be based on commonly available market analysis data, e.g., (1) geographic segmentation, (2) demographic segmentation, (3) psychological segmentation, (4) psychographic segmentation, (5) sociocultural segmentation, (6) use-related segmentation, (7) use-situation segmentation, (8) benefit segmentation, and (9) hybrid segmentation. More information may be found in a book entitled Consumer Behavior, by Leon G. Schiffman and Leslie Lazar Kanuk published by Prentice hall, New Jersey 1999.

The analysis of different segmentations permits the selection of suitable advertisements to be directed to specific cable nodes and groups of users corresponding to different cable nodes. For instance, an advertisement for a baby stroller could reach parents of children under five years old—and only those individuals in that group. The other publicly or privately available data regarding the subscribers may also be collected.

FIG. 7 is particularly applicable for cable-based systems. However, a similar method can be employed in a Local Multipoint Distribution System/Multichannel Multipoint Distribution System (LMDS/MMDS). In this embodiment, separate ad channels may be created corresponding to one or more groups. However, in an LMDS, the ad channels are transmitted based on cells, wherein each cell is defined by the area served by a broadcast transmitter associated with a group and each cell would receive only that ad channel corresponding to the cell group. This requires that the ad channel switching/insertion occurs at the head end. In a preferred embodiment, the LMDS system providing video services and a generic ad channel, would generate different ad channels (for different cells/groups) and send only the one and appropriate ad channel to each cell depending on the group membership of that cell. The term cell is used to denote a “subscriber serving area” served by a single broadcast transmitter and typically serves 500-2000 homes.

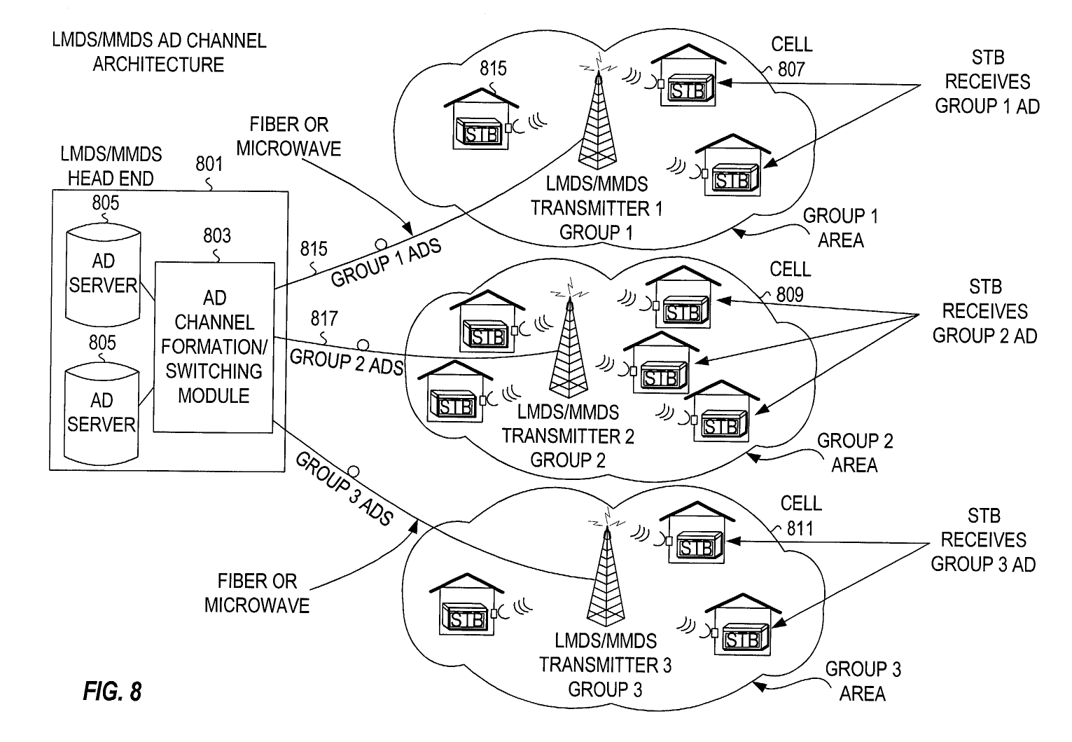

FIG. 8 illustrates one exemplary implementation for an LMDS/MMDS architecture. As shown in FIG. 8, at the LMDS/MMDS head end 801, there is provided an ad channel formation/switching module 803 coupled to one or more ad servers 805. The ad channel formation/switching module 803 receives one or more advertisements from the ad servers, groups them together and transmits the advertisements to one or more subscriber groups.

Unlike SDV or cable-based systems, in LMDS/MMDS systems, subscriber groups correspond to cells. Generally, a subscriber area covered by an LMDS/MMDS transmitter is known as a cell and the subscribers located within the cell may be known as a subscriber group.

In accordance with the principles of the present invention, the subscriber group corresponding to a cell may be characterized. For exemplary purposes, in FIG. 8, cell #1 (807) is shown to correspond to LMDS/MMDS transmitter #1, and the subscribers located within this cell are termed as group #1. The targeted advertisements for the group #1 are transmitted via a connection 815, wherein the connection 815 may be a fiber or a microwave. Similarly, another group of advertisements are selected and transmitted to cell 809 via connection 817. For exemplary purposes, a third group of ads are shown to be transmitted to cell 811. The ads are delivered from the transmitters to the STBs via wireless connections.

It is to be noted that in an LMDS/MMDS environment, all the STBs belonging to a particular cell receive the same advertisements, however, these advertisements are not network-based ads, but instead are based on a group of subscribers corresponding to a cell, e.g., subscribers located in cell 807 will receive group #1 advertisements, subscribers located in cell 809 will receive group #2 advertisements, etc.

At the subscriber end, in a simplest embodiment of the invention, the advertisements are inserted in the avails in the channel to which the STB is tuned. Such insertion functionality is applicable for SDV, cable-based, as well as LMDS/MMDS systems. In a more practical embodiment, the ads are displayed in the avails in accordance with an algorithm that takes into account both the order of the advertisements and the duration of the avail relative to the duration of the ads identified in the queue such that the duration of the advertisement(s) inserted into the avail match the duration of the avail.

It should be apparent to those of skill in the art, that the number of particular embodiments of the invention are practically limitless. Technologies for inserting data such as advertisements into other data streams is well known. In accordance with the invention, ads stored in digital format could be readily inserted into digital video streams as well as analog video streams. Further, as previously noted, the invention is not limited to insertion of ads but can apply to any form of data and also is not limited to television but can be used to insert any information into any data stream.

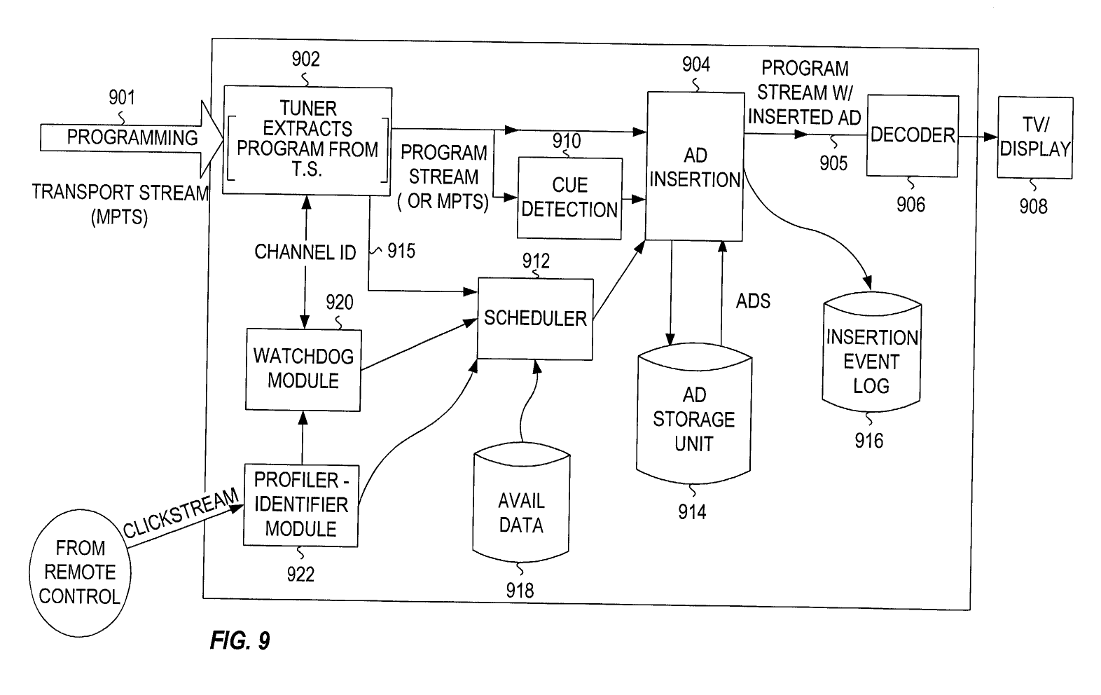

FIG. 9 is a functional block diagram illustrating advertisement insertion according to one embodiment of the present invention. In this example, the received programming stream 901 is in the form of a DVB transport stream, i.e., a multiple program transport stream (MPTS). In the tuner function 902, the channel selected by the subscriber is extracted and demodulated from the MPTS. This channel carries digital cue tones which are detected by a cue detection module 910. The advertisement to be inserted in the next detected avail has already been retrieved, e.g., from the scheduler 912 using the avail data and prioritization or other scheduling algorithm. The advertisement insertion module 904 inserts or splices the advertisement according to the queue tone timing. The resulting program stream 905 with the substituted advertisement is decoded by decode module 906 and sent to the television 908 or other display device.

The advertisement insertion of the present invention can be combined with a time/program based set of rules in which case the ad to be presented is determined in part by the time-of-day program being watched or a combination thereof.

It is also possible to use a system such as described in the aforementioned PCT Publication No. WO 033233A1 to determine who is watching the television and to organize the queue based at least partially on that criterion. Other methods include the use of personal identification numbers (PINs) to determine who is viewing the television or monitoring interaction with an Electronic Program Guide (EPG). By characterizing the household, it is possible to establish the most appropriate queues for each time of day.

Program based rules also may be used in conjunction with the queues to provide a combination of “linked” advertising and advertising in accordance with the concepts of the present invention. Using such a combination, the order of the advertisements may be varied depending upon the program being watched. This allows a particular advertiser to link to a certain program. In one embodiment, the advertisement is moved to the top of the queue when a particular program is being watched. In an alternate embodiment, program dependent lists can be created, such that there is a list for a program such as “ER” and a different one for “Survivor”.

The scheduler 912 is the retrieval circuit which receives the instructions for organization of the advertisement in the memory and then organizes the advertisement (not separately shown in FIG. 9) in accordance with the received instructions. In this exemplary embodiment, the scheduler retrieves from a dedicated control channel 915 in the media stream 901. However, as previously noted, this is just one of many possible transport streams instructions. The scheduler also provides a schedule and notifies the advertisement insertion module 904 of the schedule.

When the cue tone is detected by cue detection module 910, the advertisement insertion module 904 requests the appropriate advertisement from the advertisement storage unit 914 which then sends the advertisement to the insertion module 904. The advertisement insertion module then inserts the advertisement with the proper timing.

In this exemplary embodiment, the advertisements that are stored into the advertisement storage unit 914 are received over a dedicated advertisement channel in the media stream. For instance, the scheduler 912 may include circuitry for picking out the appropriate advertisements for the particular STB from a continuous stream of advertisements as previously described and writing them to the advertisement storage unit 914. The watchdog module 920 notifies the scheduler 912 of any changes that may require a queue update or switching among multiple queues as previously described. For instance, a profiler-identifier module 922 can process information such as data as to the program being watched and remote control operation, such as volume control and channel change control, to attempt to determine which particular viewer in a subscriber household is viewing the television in order to choose among the various queues as previously described. The avail data block 918 provides information to the scheduler 912 about various available advertisement opportunities.

The advertisement insertion module 904 generates and stores an advertisement insertion log 916 of all insertion events. This is essentially the schedule of the ads inserted and whether or not they were inserted successfully and/or displayed. The insertion logs will eventually be sent upstream to the central office to be used for billing advertisers based on the ads that have been-played at each subscriber's location.

Since FIG. 9 is functional block diagram, the blocks in FIG. 9 do not necessarily correspond to separate hardware components, such as illustrated in FIG. 2. For exemplary purposes however, blocks 912 and 916 represent portions of memory and might correspond to any one or more of the memories 210, 212 and 214 shown in FIG. 2. Functional blocks 904, 906, 910, 912, 920, and 922 represent processing steps and might correspond to the system control unit 204 and the channel processing circuit 222 shown in FIG. 2. As processing steps, these blocks may correspond to software executed by any form of digital processor in the system control unit. However, any one or more of these functions could be performed by dedicated hardware (e.g., an analog circuit) within the system control unit or separate therefrom. It should be understood that the term circuit as used in this specification is intended to be all-inclusive and to encompass analog circuits and digital circuits, including finite state machines, digital signal processors, computers, central processing units, ASICs, and programmed general purpose processors. Functional block 902 corresponds to one or more of tuner block 218, demodulator block 220 and demultiplexer block 224 in FIG. 2.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. In a television network environment, the television network environment being a switched digital video system, a cable-based system, and satellite-based system, a method for delivering targeted advertisements to one or more subscribers, the method comprising:
selecting one or more targeted advertisements to be transmitted to one or more subscribers;
grouping one or more selected advertisements in a group; and
transmitting the grouped advertisements to the subscriber equipment.

2. The method of claim 1, wherein the advertisements are grouped in a time-division multiplexed channel.

3. The method of claim 2, wherein the time-division multiplexed channel is a high-speed channel.

4. The method of claim 2, wherein the time-division multiplexed channel is an analog channel.

5. The method of claim 2, wherein the advertisements are grouped in an ATM-based channel.

6. The method of claim 5, wherein the ATM-based channel is a 6 MHz digital channel.

7. The method of claim 6, wherein the ATM-based channel is a Virtual Path Identifier/Virtual Channel Identifier (VPI/VCI).

8. The method of claim 1, wherein the grouped advertisements are encoded and transmitted as conventional programming.

9. The method of claim 1, wherein the plurality of ad channels are comprised within a single 6 MHz digital channel.

10. The method of claim 1, further comprising:
assigning each selected advertisement a unique AD_ID;
assigning each set-top box (STB) to one or more groups;
forming a time-division multiplexed channel by utilizing different AD_IDs;
forming a timing table associated with the time-division multiplexed channel, the timing table illustrating the timing of the various advertisement groups; and
transmitting the time-division multiplexed channel and the timing table to one or more STBs.

11. The method of claim 10, wherein the STB uses the timing table used to select appropriate advertisements from the time-division multiplexed channel.

12. The method of claim 10, wherein the time-division multiplexed channel comprises one or more time slots, each time slot hosting a group of advertisements.

13. The method of claim 10, wherein the set-top box decodes the received time-division multiplexed channel and identifies the timing of the advertisement to be downloaded.

14. The method of claim 10, wherein the set-top box further identifies which advertisements to store, and saves the identified advertisement during one or more corresponding splice windows.

15. The method of claim 1, further comprising:
assigning each selected advertisement a unique AD_ID;
forming one or more advertisement groups by utilizing unique AD_IDs;
assigning each advertisement group to a unique VPI/VCI, thereby creating a GROUP-VPI/VCI table; and
transmitting each group of advertisements on a selected VPI/VCI to one or more subscribers.

16. The method of claim 15, wherein each STB receives one or more advertisements for the corresponding STB.

17. The method of claim 15, wherein the GROUP-VPI/VCI table comprises the identity of the STBs, the identity of the advertisement group, and the identity of the VPI/VCI channel.

18. In a television network environment, the television network environment being a switched digital video system, a cable-based system, and a satellite-based system, an advertisement management system comprising:
an advertisement channel generator for receiving one or more advertisements and their corresponding group information and generating an advertisement channel comprising the advertisements and the associated group information; and
a set-top box for receiving the advertisement channel and the corresponding advertisements.

19. The apparatus of claim 18, wherein the set-top box further comprises a memory for storing the selected advertisements.

20. The apparatus of claim 18, wherein the advertisement channel is a VPI/VCI channel.

21. The apparatus of claim 20, wherein each STB receives one or more advertisements corresponding to the assigned VPI/VCI channel.

22. The apparatus of claim 18, wherein the advertisement channel is a time-division multiplexed channel.

23. The apparatus of claim 22, wherein the time-division multiplexed channel comprises timing information corresponding to each of the advertisement groups.

24. The apparatus of claim 22, wherein the STB retrieves one or more advertisements by identifying the corresponding timing information.
